(19) United States
(12) Patent Application Publication
(10) Pub. No.: US 2008/0029408 A1
(43) Pub. Date: Feb. 7, 2008

(54) Contact Lens, Container And Insert For Avoiding Infection Of The Eye

(76) Inventor: Thorkild Andersen, Hadsten (DK)

Correspondence Address: FITCH EVEN TABIN AND FLANNERY, 120 SOUTH LA SALLE STREET, SUITE 1600, CHICAGO, IL, 60603-3406, US

(21) Appl. No.: 10/599,017

(22) PCT Filed: Mar. 17, 2005
(86) PCT No.: PCT/DK05/00178

§ 371 Date: Jun. 22, 2007

(30) Foreign Application Priority Data
Mar. 17, 2004 (DK) PA200400432

(51) Int. Cl. A45C 11/04; G02C 7/04

(52) U.S. Cl. 206/5.1; 351/160 R

(57) ABSTRACT

The present invention relates to a container, an insert and a contact lens for avoiding contamination and infection of the eye. The invention is characterised in that the container, the insert and the contact lens are made of a mouldable material, which material comprising a predetermined concentration of silver nano particles and/or titanium oxide photocatalyst.

### FIELD OF THE INVENTION

The present invention relates to a container, an insert and a contact lens for avoiding contamination and infection of the eye.

### BACKGROUND OF THE INVENTION

Cleaning and disinfection of contact lenses is a known way of avoiding infection of the eye during use of contact lenses. Cleaning and disinfection of contact lenses has become increasingly important due to the fact that the number of infections of the eye and the surroundings of the eye has increased over the years caused by insufficient cleaning and disinfection of the contact lenses before use.

For persons using contact lenses, it is known to use a cleaning system comprising a container in which cleaning fluids are handled to clean and disinfect the contact lenses before placing the lenses into the eyes to avoid a bacterial infection of the eyes. This way of cleaning contact lenses may be time-consuming, awkward and expensive, which may be the reason for the lack of sufficient cleaning causing the increased number of infections of the cornea and conjunctiva of the eye. Studies have shown typically more than 50% with bad compliance.

The cleaning fluids used in these known cleaning processes are often hydrogen peroxide, chlorhexidine or derivates of chlorhexidine etc. When using hydrogen peroxide it is very important to neutralise the hydrogen peroxide 100% before entering the contact lenses into the eyes of the user, or otherwise the eyes will be negatively affected, such as red eyes, burning and stinging. Likewise, it is important that the lenses are rinsed with a sufficient amount of sterile saline solutions before entering the contact lenses into the eyes, so that the user will not develop allergy towards the cleaning fluids. These cleaning processes comprise therefore some disadvantages and may be risky to use.

Especially, the popular “All-in-one” cleaning fluid are at risk of causing an infection of the eyes. This is due to the fact that when using the “All-in-one” cleaning fluids, it is required to rub the lenses before entering them into the cleaning and disinfecting fluids, and subsequently to rinse the lenses. By rubbing the contamination of the lenses are reduced around 90% and thereby it is possible to clean and disinfect the lenses by using the “All-in-one” cleaning fluids. The “All-in-one” cleaning fluids are special due to the low concentration of cleaning and disinfection agents. Person using the “All-in-one” cleaning fluid for cleaning and disinfection of their contact lenses often omit from rubbing the lenses, whereby the “All-in-one” cleaning fluid is not sufficient to clean and disinfect the lenses, and furthermore the persons may choose not rinse the lenses afterwards. This “All-in-one” application is therefore perhaps one of the main reasons for the increased number of infections of the cornea and conjunctiva of the eye.

Furthermore, there is a risk of infection during the placement of the lenses into the eyes, which is normally done by the fingers, whereby the contact lenses are at risk of introducing bacteria into the eye. This may be another reason for the increased number of infections of the cornea, as previously mentioned.

Thus, there is a need for an improved cleaning system for cleaning of contact lenses which is easier to use, less risky to use, less time-consuming and more inexpensive, so that infection of the eyes will be reduced and consequently the infections of the cornea of the eye.

### SUMMARY OF THE INVENTION

It is therefore an object of the present invention to wholly or partly overcome the above mentioned disadvantages and drawbacks of the prior art.

More specifically, it is an object to provide a contact lens, a container for cleaning a contact lens as well as an insert for use in connection with a container, where said contact lens, container and insert minimize the risk for contamination, which often leads to an infection of the eye via the contact lens.

The above object together with numerous other objects, advantages and features, which will become evident from the detailed description below, is obtained according to a first aspect of the invention by a container according to the independent claim 1.

By adding the insert as mentioned above to a container for storing/cleaning contact lenses, it is obtained that contact lenses are cleaned from bacteria with only sterile water without using any risky preparations, which preparations may cause the development of an allergy and/or infections of the cornea of the eye.

The above mentioned object is further obtained according to a second aspect of the invention by an insert according to the independent claim 3.

This insert is advantageous, in that it can be used to clean conventional contact lenses from bacteria in a conventional container for storing/cleaning contact lenses, such as a contact lens case, by placing the insert into the container containing a fluid.

The above mentioned insert when covered with fluid will liberate silver nano particles to the fluid for reacting with the bacteria and the like and for reacting with the surface of a contact lens and thereby clean and disinfect the contact lens.

The contact lens according to the third aspect of the present invention provides a contact lens which in connection with a fluid, such as tears of the eye, is self-cleaning by releasing silver nano particles into the fluid for a reaction with the bacteria of the surface and the surroundings of the contact lens. In this way the contact lens is kept clean from bacteria during wearing.

A contact lens according to the invention is especial useful when using the contact lens day and night in up to 30 days due to the lens is able to help the eye in keeping the eye and its surroundings clean from infections.

Additionally, the contact lens according to a third aspect of the present invention when being in a fluid, e.g. in a container, is able to clean and disinfect itself before being inserted into an eye of a person.

Furthermore, the contact lens according to the third aspect may be used for reduction of a certain amount of bacteria in an infected eye of having microbial, achantamoeba, vira or fungal activity. In this way the contact lens is able to disinfect the eye and its surroundings when being in the eye.

The above mentioned object of the invention is further obtained according to a fourth aspect of the invention by a container according to the independent claim 8.

The container according to the fourth aspect of the present invention provides a container, which in connection with a fluid is capable of cleaning the surface and surroundings of a conventional contact lens by releasing silver nano particles into the fluid for a reaction with microbial, achantamoeba, vira or fungal activity. It is hereby obtained that a conventional contact lens is cleaned from bacteria before inserting the lens into an eye of a person without using preparations, such as cleaning fluids as mentioned above, which may cause the development of allergy and infections of the eye due to bad compliance with the cleaning system.

Preferred embodiments according to the invention are stated in the dependent claims.

### BRIEF DESCRIPTION OF THE DRAWINGS

The above, as well as additional features and advantages of the present invention, will be better understood through the following illustrative and non-limiting detailed description of preferred embodiments of the present invention, with reference to the appended drawings, wherein:

FIG. 1 shows a contact lens according to the invention,

FIG. 2 shows a container according to the invention, and

FIG. 3 shows an insert according to the invention.

### DETAILED DESCRIPTION OF THE PREFERRED EMBODIMENTS

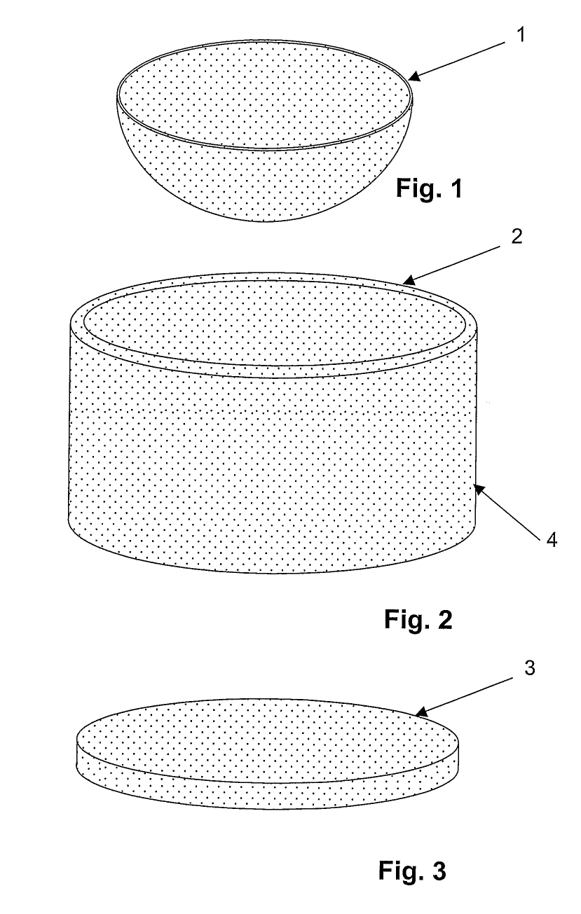

FIG. 1 shows a contact lens 1 according to an embodiment of the invention, which is made of a mouldable material comprising a predetermined concentration of silver nano particles and/or titanium oxide photocatalyst, illustrated by small dots. The contact lens 1 as shown has a curved shape so as to fit the cornea of the eye.

When a contaminated contact lens L according to the invention is in connection with a fluid, such as sterile saline solutions, tears of the eye or the like, the contact lens 1 is capable to clean its own surface and its immediate surroundings, such as the fluid in the eye, due to the concentration of silver nano particles.

Additionally, a contact lens according to the invention may have different concentrations, so as to fit the purpose of the contact lens. One purpose of a contact lens is to clean and disinfect itself in a fluid in a container. Another purpose of the contact lens of the present invention is to help the eye avoid infection during the wearing of the contact lens. A third purpose of the contact lens according to the present invention is to be able to reduce the amount of infection in an infected eye and thereby kill any microbial, vira, achantamoeba or fungal activity, which ability of the lens will require an increased amount of silver nano particles compared to the first and second purpose.

To obtain a clean contact lens 1 it is important that the lens 1 is covered with fluid during the cleaning process in a container and for reasons of keeping the contact lens 1 flexible.

Tests have shown that silver nano particles have an antibacterial effect. There are so far no known bacterial strains that are resistant to silver. This effect is in particular useful when using contact lenses 1 over period of 30 days, which lenses 1 will be at risk of being infected during placing of the lens 1 into the eye or when being in the eye due to the environment of the user of contact lenses, which will cause the eye to be infected. Furthermore, this effect has been useful when the contact lens 1 is positioned in the eye, if the contact lens 1 should be contaminated during insertion by the fingers of the user or if the eye itself is bacterially infected due to the lens 1 will help the eye avoid any infections or kill any microbial, vira, achantamoeba or fungal activity. Whether the contact lens 1 is able to keep the eye from getting infected or to kill the infectious organism in the eye depends on the amount of silver in the contact lens 1.

The contact lens 1 according to this invention is made of a mouldable material, such as silicone, polymers, rubber, HEMA-materials (hydroxyethylmethacrylate materials) or any other suitable resilient material, which is mouldable and can comprise silver nano particles and in which material the particles or the silver ions (Ag+) are capable of migrating.

When a material is moulded into an element, such as a contact lens 1, a container 2 for contact lenses 1, an insert 3 or the like, the silver nano particles or the silver ions, moulded or embedded into the material of the element, posses the effect that they migrate from inside of the material to the surface of the element until a chemical equilibrium is established at the surface. These silver nano particles or silver ions are especially active in a hydrophilic environment, such as sterile saline solutions or the like. Subsequently, the element is placed in a fluid, the silver nano particles or silver ions are rinsed away from the surface of the element and into the fluids, whereupon new silver nano particles or silver ions migrate out to the surface of the contact lens to establish a new chemical equilibrium. The silver nano particles or silver ions thus released in the fluid are then free to react with the bacteria or other microbes and thereby to clean the surface of the element and the fluid surrounding it. By using this cleaning process the contact lens 1 according to this invention is capable of cleaning its own surface and the areas which immediate surrounds it.

The contact lens 1 is likewise capable of cleaning its surface and the fluid surrounding it when placed in the eye of a person by using the fluid in the eye in the cleaning process, as previously described, to free silver nano particles or silver ions to react with the infection. Tests have shown that the amount of silver entering the fluid in the eye during this cleaning process is no more than the amount of silver allowed in conventional drinking water. Consequently, it may also be possible to disinfect an eye having microbial, fungal activity or any other infection, by placing the contact lens 1 according to the invention into the eye. To obtain this last mentioned effect an increased amount of silver nano particles in the mouldable material is required.

Furthermore, it is obtained that so far as there should be some contamination left when inserting the contact lens 1 into the eye, the contact lens 1 will be capable of cleaning these remains of contamination by releasing silver nano particles into the fluid of the eye. These remains of infection, caused by insufficient time to clean the contact lenses 1, may subsequently be cleaned when positioned in the eye, and they will therefore no longer cause the known problems, such as infections of the areas of the eye, such as the cornea and conjunctiva of the eye.

FIG. 2 shows a container 2 according to an aspect of the invention. The container 2 is made of a mouldable material comprising a predetermined concentration of silver nano particles and/or titanium oxide photocatalyst. When the container 2 is filled with a fluid, such as sterile saline solutions or the like, the previously mentioned cleaning process takes place by releasing silver nano particles or silver ions of the inner surface of the container into the fluid inside the container 2. Subsequently, a user of contact lenses 1 can introduce a contact lens 1, even a conventional contact lens having no silver particles, into the fluid of the container 2 and thereby clean the contact lens from bacteria. Thus, it is possible to clean conventional contact lenses without using any chemical preparations. A cleaning process is hereby obtained which defiantly reduces the infection risk of the eyes of the user in comparison with conventional known cleaning processes. The cleaning process according to the invention is inexpensive and simple to use, the user just needs only to add saline solution to clean the contact lens, which furthermore gives an optimal compliance with the eye.

The container 2 shown in FIG. 2 has a cylindrical shape with a wall and a bottom, which container 2 is adapted to comprise a fluid. The container 2 is shown with an open top without a lid, but may as well have a different shape and be provided with a lid within the inventive idea of the present invention. During use of the container 2 it is recommended to use a lid. The lid may further assume different shapes with or without gratings or baskets for holding the contact lenses 2, such as a flat lens case or a cylindrical case.

The container may be made of a transparent material which not is UV blocked.

Furthermore, by using a container 2 according to the invention the problems of the conventional cleaning processes are overcome. There is no longer any risk of damaging the eye with left hydrogen peroxide or initiating any allergy towards the cleaning fluids.

FIG. 3 shows an insert 3 according to an embodiment of the invention, which insert 3 is made of a mouldable material comprising silver nano particles and/or titanium oxide photocatalyst, illustrated by small dots in the drawing. When the insert 3 is placed in a conventional cleaning/storing container for contact lenses and a fluid, such as sterile saline solutions, is held over the insert 3 in the container, so that at least part of a surface of the insert 3 is in contact with the fluid, the silver nano particles or silver ions (Ag+) are rinsed or flushed off this surface and thereby released into the fluid for reacting with bacteria or the like. When a conventional contact lens subsequently is placed in the fluid in the container, the contact lens is cleaned by the silver nano particles or the silver ions in the fluid.

The insert 3 shown in FIG. 3 is to be placed in the container as mentioned, whereupon a contact lens is placed in the container together with the insert 3, and the fluid is to cover both the insert 3 and the contact lens to make the cleaning process of releasing silver nano particles or silver ions function.

The insert 3 according to another embodiment of the present invention may be placed as an insert 3 in a conventional container for storing/cleaning contact lenses or placed in the lid of the same.

The insert 3 according to the invention may as well have the shape of a cylinder, lining, bowl, pipe or any other suitable shape for insertion into a container for contact lenses.

The concentration of silver nano particles mentioned above may advantageously be above 0.001% Ag, preferably in the range from 0.002% Ag to 2.0%, most preferably from 0.002% Ag to 0.0099% Ag, so as to have an effective disinfection effect on the contact lenses. The higher the concentration is, the faster the cleaning process of the contact lenses will be carried out. The concentration of silver nano particles mentioned in this application may as well be silver ions (Ag+) or a combination of both silver ions and silver nano particles.

Furthermore, tests have shown that concentrations of silver nano particles in the material as mentioned above 0.002% Ag may provide a bacteriostatic effect and concentrations above 1% Ag may provide a bactericidal effect.

The silver nano particles may have a particle size range of 1 to 100 nm, which is to be adjusted to the choice of mouldable material used for the contact lens, container or insert 3 according to the present invention. Furthermore, tests have shown that the Ag+ are much better released when the silver is present in very small particles, which is due to the higher surface area.

The amount of silver nano particles in the insert, the contact lens and the container according to the present invention may be adjusted to the time period it is to be used. A contact lens which is to be worn of the user for 30 days needs to have more silver than a contact lens which is to be worn for only a day. Likewise, the lifetime of the cleaning ability of the container and of the insert may be adjusted by the amount of silver nano particles.

The invention relates to conventional contact lenses, but may as well be used for cleaning disposable contact lenses or disinfection of an eye having microbial, fungal activity or the like, with disposable contact lenses comprising silver nano particles.

The contact lens, container or insert 3 according to the invention may be moulded or embedded as previously mentioned, additionally it may also be coated with a layer comprising silver nano particles and/or titanium oxide photocatalyst.

Furthermore the invention relates to a container according to the above mentioned for disinfecting a contact lens when placed in the container. Furthermore the invention relates to an insert 3 according to the above mentioned for disinfecting a contact lens when placed in a fluid contained in a container.

By using the contact lens, container for storing/cleaning a contact lens or insert 3 to be placed into a container for storing/cleaning a contact lens according to the invention, it is obtained that the surface of the contact lens and the fluid surrounding the contact lens are cleaned.

By using a contact lens with a concentration of silver nano particles, it is obtained that the contact lens is provided with an antibacterial effect.

Furthermore, the fluid used in connection with the cleaning of the surface of a contact lens and its surroundings mentioned above could besides saline solutions also be saline solutions added some agents for making the wearing of the lenses more comfortable or preparations for other purposes than bacterial cleaning of contact lenses.

Advantagously, the material according to the invention may also comprise titanium oxide photocatalyst (TiO₂), which may be used in the form of titanium oxide powder, said powder consists of nano particles so that a large surface area of the particles is obtained. Hereby is obtained that the contact lens, insert and containers according to the invention possess an improved photocatalytic efficiency.

In addition, if the contact lens, insert and containers according to the invention comprise a combination of silver and titanium oxide particles an expedient antibacterial effect, detoxication effect as well as enhanced photocatalytic effect to the products is obtained.

The mechanism of photocatalytic reaction is known in the art and will not be explained in detail herein.

According to the inventive idea silica oxide (SiO₂) as well as titanium oxide (TiO₂) may be used as carriers for the silver nano particles, which are to be used in the material making the contact lens, insert and containers according to the invention.

The matter is that the contact lens, insert and containers according to the invention may comprise either silver nano particles or titanium oxide photocatalyst or a comination thereof.

Although the invention above has been described in connection with preferred embodiments or aspects of the invention, it will be evident for a person skilled in the art that several modifications are conceivable without departing from the invention as defined by the following claims.

1. A container wherein said container being adapted to comprise a fluid and at least one contact lens, the container comprises an insert said insert being made of a mouldable material, such as silicone, rubber or polymer, and said material comprising a predetermined concentration of silver nano particles and/or titanium oxide photocatalyst.

2. A container as claimed in claim 1, wherein the silver nano particles have a particle size range of 1 to 100 nm, and/or the concentration of silver is above 0.001% Ag, preferably from 0.002% Ag to 2.0% Ag, most preferably from 0.002% Ag to 0.0099% Ag.

3. An insert for a container for cleaning and/or disinfect contact lenses said insert being made of a mouldable material, said material comprising a predetermined concentration of silver nano particles and/or titanium oxide photocatalyst.

4. An insert as claimed in claim 3, wherein the silver nano particles have a particle size range of 1 to 100 nm, and/or the concentration of silver is above 0.001% Ag, preferably from 0.002% Ag to 2.0% Ag, most preferably from 0.002% Ag to 0.0099% Ag.

5. A contact lens made of a mouldable material, said material comprising a predetermined concentration of silver nano particles and/or titanium oxide photocatalyst.

6. A contact lens as claimed in claim 5, wherein the silver nano particles have a particle size range of 1 to 100 nm, and/or the concentration of silver is above 0.001% Ag, preferably from 0.002% Ag to 2.0% Ag, most preferably from 0.002% Ag to 0.0099% Ag.

7. A contact lens as claimed in claim 5 for reduction of an amount of bacteria in an infected eye having microbial, vira, achantamoeba or fungal activity.

8. A container wherein said container being adapted to comprise a fluid and at least one contact lens, said container being made of a mouldable material, and said material comprising a predetermined concentration of silver nano particles and/or titanium oxide photocatalyst.

9. A container as claimed in claim 8, wherein the silver nano particles have a particle size range of 1 to 100 nm, and/or the concentration of silver is above 0.001% Ag, preferably from 0.002% Ag to 2.0% Ag, most preferably from 0.002% Ag to 0.0099% Ag.

10. Use of silver nano particles and/or titanium oxide photocatalyst for a contact lens, a container or an insert for a container.
